(19) United States
(12) Patent Application Publication
(10) Pub. No.: US 2026/0005354 A1
(43) Pub. Date: Jan. 1, 2026

(54) ENERGY STORAGE APPARATUS

(71) Applicant: GS Yuasa International Ltd., Kyoto (JP)

(72) Inventors: Takashi TAMMITSU, Kyoto (JP); Akira WADA, Kyoto (JP); Shunsuke OKUTA, Kyoto (JP); Nobuaki SHIBATA, Kyoto (JP)

(73) Assignee: GS Yuasa International Ltd., Kyoto (JP)

(21) Appl. No.: 18/992,186

(22) PCT Filed: Jul. 3, 2023
(86) PCT No.: PCT/JP2023/024557

§ 371 Date: Jan. 8, 2025

(30) Foreign Application Priority Data
Jul. 8, 2022 (JP) 2022-110752

(51) Int. Cl. H01M 50/211; H01M 50/249; H01M 50/271; H01M 50/284

(52) U.S. Cl. CPC H01M 50/211; H01M 50/271; H01M 50/284; H01M 50/249

(57) ABSTRACT

An energy storage apparatus includes an energy storage unit and an outer case that accommodates the energy storage unit. The energy storage unit includes a plurality of energy storage devices arrayed in a predetermined direction, and a first holding member that is adjacent to the plurality of energy storage devices in the predetermined direction and holds the plurality of energy storage devices. The first holding member is joined to the outer case.

### TECHNICAL FIELD

The present invention relates to an energy storage apparatus.

### BACKGROUND ART

Patent Literature 1 discloses an energy storage system in which an energy storage unit obtained by assembling a plurality of pouch-type capacitor cells to a frame into a unit is accommodated in a housing.

### PRIOR ART DOCUMENT

### Patent Document

Patent Document 1: JP-A-2007-110035

### SUMMARY OF THE INVENTION

### Problems to be Solved by the Invention

If the energy storage unit moves in the housing, the energy storage unit may collide with the housing and be damaged.

The present invention has been made by the inventor of the present application with a new focus on the above problems, and an object of the present invention is to enhance vibration resistance or impact resistance of an energy storage apparatus.

### Means for Solving the Problems

An energy storage apparatus according to one aspect of the present invention includes an energy storage unit and an outer case that accommodates the energy storage unit. The energy storage unit includes a plurality of energy storage devices arrayed in a predetermined direction, and a first holding member that is adjacent to the plurality of energy storage devices in the predetermined direction and holds the plurality of energy storage devices, and the first holding member is joined to the outer case.

### Advantages of the Invention

According to the present invention, the vibration resistance or impact resistance of the energy storage apparatus can be enhanced.

### BRIEF DESCRIPTION OF THE DRAWINGS

FIG. 1 is a perspective view showing an external appearance of an energy storage apparatus according to an embodiment.

FIG. 2 is an exploded perspective view showing each constituent element when the energy storage apparatus according to the embodiment is disassembled.

FIG. 3 is a cross-sectional perspective view showing a joining structure between an outer case and an energy storage unit according to the embodiment.

FIG. 4 is a cross-sectional perspective view showing a joining structure between an outer case and an energy storage unit according to a first modification.

### MODE FOR CARRYING OUT THE INVENTION

(1) An energy storage apparatus according to one aspect of the present invention includes an energy storage unit and an outer case that accommodates the energy storage unit. The energy storage unit includes a plurality of energy storage devices arrayed in a predetermined direction, and a first holding member that is adjacent to the plurality of energy storage devices in the predetermined direction and holds the plurality of energy storage devices, and the first holding member is joined to the outer case.

According to the energy storage apparatus according to one aspect of the present invention, since the first holding member provided at the end portion of the energy storage unit is joined to the outer case, the energy storage unit is fixed on at least one side in the outer case. Accordingly, the energy storage unit is stabilized inside the outer case. Accordingly, it is possible to enhance the vibration resistance or impact resistance of the energy storage apparatus.

(2) In the energy storage apparatus described in (1), the outer case may include an outer case body having an opening in one end portion in the predetermined direction, and an outer case lid body that is attached to the one end portion of the outer case body and closes the opening.

According to the energy storage apparatus described in (2), since the energy storage unit is accommodated in the outer case body having an opening in one end portion in a predetermined direction, when the first holding member is disposed on the other end portion of the energy storage unit in the predetermined direction, the first holding member can be joined to the bottom portion of the outer case body.

That is, when the energy storage unit is accommodated in the outer case body, the first holding member provided at the other end portion of the energy storage unit can be joined to the outer case body. On the other hand, when the first holding member is disposed at one end portion of the energy storage unit in the predetermined direction, the first holding member can be joined to the outer case lid body. That is, when the outer case lid body is attached to one end portion of the outer case body, the first holding member provided at one end portion of the energy storage unit can be joined to the outer case lid body. In this manner, the first holding member provided at the end portion of the energy storage unit can be smoothly joined to the outer case.

(3) In the energy storage apparatus described in (1) or (2), the energy storage unit further may include a second holding member that holds the plurality of energy storage devices, and the second holding member is disposed at a position where the second holding member interposes the plurality of energy storage devices together with the first holding member in the predetermined direction, and is joined to the outer case.

According to the energy storage apparatus described in (3), since the plurality of energy storage devices are sandwiched and held by the first and second holding members, the plurality of energy storage devices are further stabilized inside the outer case by the first and second holding members. Further, since the first holding member is joined to the outer case lid body and the second holding member is joined to the outer case body, the energy storage unit is fixed on both sides in the outer case. Accordingly, it is possible to further enhance the vibration resistance or impact resistance of the energy storage apparatus.

(4) In the energy storage apparatus described in (3), a gap may be formed between at least one of the first holding member and the second holding member and the outer case at positions corresponding to the plurality of energy storage devices.

According to the energy storage apparatus described in (4), a gap is formed between at least one of the first holding member and the second holding member and the outer case at a position corresponding to the plurality of energy storage devices and hence, the expansion of the plurality of energy storage devices can be absorbed by the gap. Therefore, it is possible to suppress the deformation of the outer case caused by the expansion of the plurality of energy storage devices. (5) In the energy storage apparatus described in (4), a circuit board may be disposed in the gap.

According to the energy storage apparatus described in (5), since the circuit board is disposed in the gap between at least one of the first holding member and the second holding member and the outer case, the circuit board can be accommodated without providing a dedicated member for covering the circuit board. If a dedicated member is unnecessary, the weight can be reduced, whereby the vibration resistance or the impact resistance can be further enhanced.

Further, when a dedicated member is unnecessary, space saving in the outer case is also possible, and the energy storage apparatus can be downsized.

### Embodiment

An energy storage apparatus according to an embodiment of the present invention (including its modification) will be described below with reference to the accompanying drawings. Note that the embodiment described below shows a comprehensive or specific example. Numerical values, shapes, materials, constituent elements, placement positions and connection modes of the constituent elements, and the like presented in the following embodiment are merely examples and are not intended to limit the present invention. In each drawing, dimensions and the like are not strictly shown.

In the following description and drawings, the arrangement direction of the outer case body and the outer case lid body of the outer case of an energy storage apparatus or the arrangement direction of a plurality of energy storage devices provided in the energy storage apparatus is defined as an X-axis direction. The projecting direction of each lead terminal of the energy storage device is defined as a Y-axis direction. The arrangement direction or vertical direction of a pair of lead terminals provided for the energy storage device is defined as a Z-axis direction. The X-axis direction is an example of a predetermined direction. The X-axis direction, the Y-axis direction, and the Z-axis direction are directions intersecting (orthogonal in the following embodiments and modifications thereof) each other.

Although the Z-axis direction may not be the vertical direction depending on a usage aspect, the Z-axis direction will be described below as the vertical direction for convenience of description. In the following description, an X-axis positive direction indicates the arrow direction side of the X axis, and an X-axis negative direction indicates an opposite side to the X-axis positive direction. The same applies to the Y-axis direction and the Z-axis direction. Furthermore, expressions indicating relative directions or postures, such as parallel and orthogonal, strictly include cases where the directions or postures are not the same. Two directions being orthogonal to each other not only means that the two directions are completely orthogonal to each other, but also means that the two directions are substantially orthogonal to each other, that is, the two directions include a difference of about several percent. In the following description, the expression “insulation” means “electrical insulation”.

### [General Description of Energy Storage Apparatus]

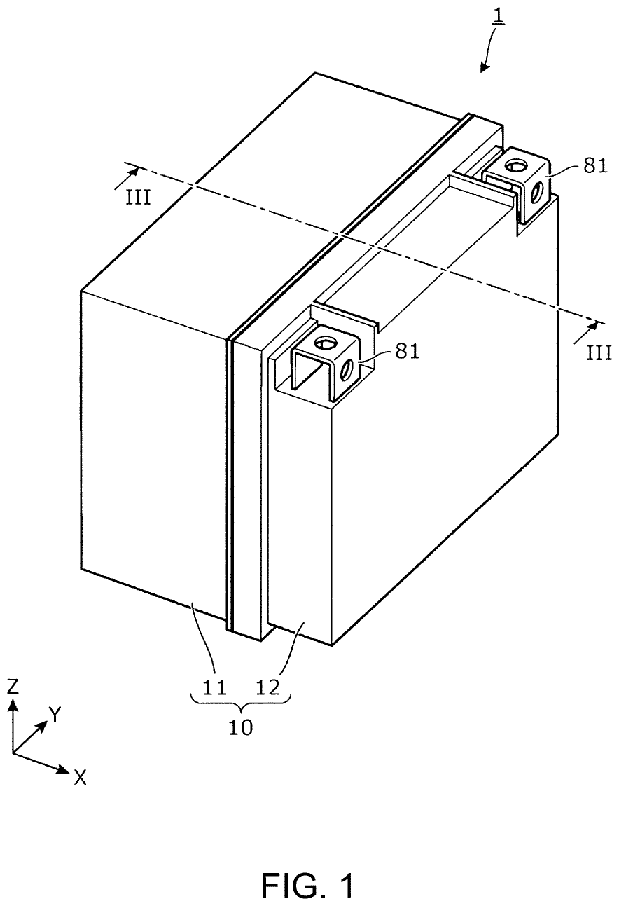

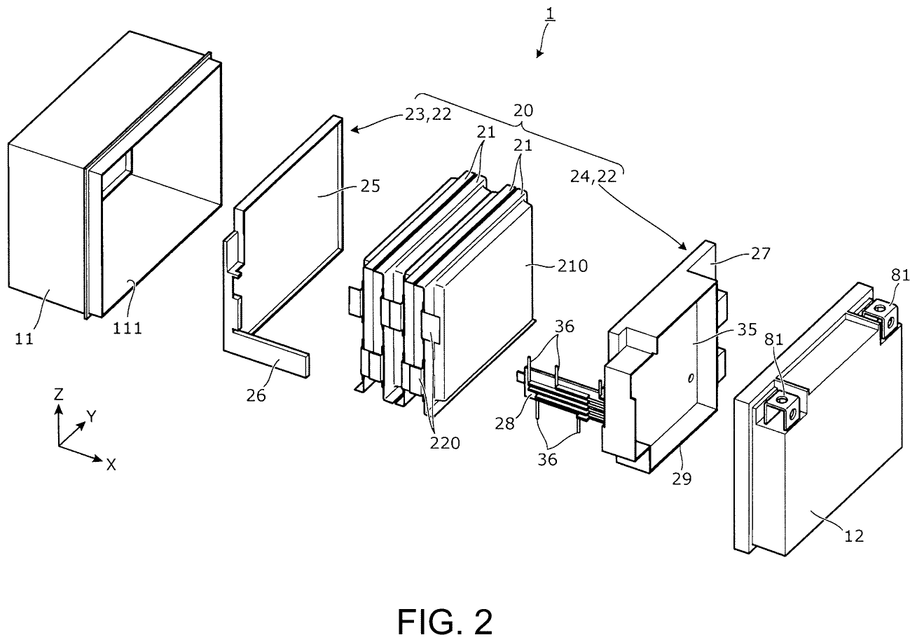

With reference to FIGS. 1 and 2, an overall description of an energy storage apparatus 1 according to an embodiment is made. FIG. 1 is a perspective view showing an external appearance of the energy storage apparatus 1 according to the embodiment. FIG. 2 is an exploded perspective view showing each constituent element when the energy storage apparatus 1 according to the embodiment is disassembled.

The energy storage apparatus 1 is an apparatus that can charge electricity from the outside and discharge electricity to the outside and has a substantially rectangular parallelepiped shape in the present embodiment. For example, the energy storage apparatus 1 is a battery module (assembled battery) used for power storage applications, power supply applications, and the like. More specifically, the energy storage apparatus 1 is used as, for example, a battery for driving or starting the engine of a moving body such as an automobile, a motorcycle, a watercraft, a ship, a snowmobile, an agricultural machine, a construction machine, or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, or the like) vehicle. Examples of the railway vehicle for an electric railway include a train, a monorail, a linear motor car, and a hybrid train including both a diesel engine and an electric motor. In addition, the energy storage apparatus 1 can also be used as a stationary battery or the like used for home use, business use, or the like.

As shown in FIGS. 1 and 2, the energy storage apparatus 1 includes an energy storage unit 20 and an outer case 10 that accommodates the energy storage unit 20. The outer case 10 includes an outer case body 11 that accommodates the energy storage unit 20 and an outer case lid body 12 that closes the outer case body 11.

The outer case 10 is a case (module case) having a rectangular shape (box shape) that forms the outer case of the energy storage apparatus 1. That is, the outer case 10 is a member that fixes the energy storage unit 20 and the like at predetermined positions and protects these elements from an impact or the like.

The outer case body 11 is a bottomed rectangular cylindrical member that is opened in the X-axis positive direction, and an opening portion of the outer case body 11 is an opening 111. The opening 111 has a substantially quadrangular shape in plan view (as viewed in the X-axis direction). In addition to the energy storage unit 20, a plurality of bus bars (not illustrated) and fuses (not illustrated) held by the energy storage unit 20 are accommodated in the opening 111 of the outer case body 11.

An outer case lid body 12 is a member that closes the opening 111 of the outer case body 11 and is joined to the outer case body 11 in a state where the opening 111 of the outer case body 11 is closed from the X-axis positive direction. A circuit board 35 is disposed at a position corresponding to the outer case lid body 12 outside the opening 111. That is, the circuit board 35 is accommodated between the outer case body 11 and the outer case lid body 12. The outer case lid body 12 has a pair of (positive electrode and negative electrode) external terminals 81. The external terminals 81 are electrically connected to the plurality of energy storage devices 21 included in the energy storage unit 20 via the bus bars, the fuses, and the circuit board 35. The energy storage apparatus 1 charges electricity from the outside and discharges electricity to the outside through the external terminals 81. The external terminal 81 is formed of a conductive member made of a metal such as a copper alloy such as brass, copper, aluminum, or an aluminum alloy.

Each bus bar is a plate-like member that electrically connects the external terminal 81 and the energy storage device 21 to each other. Each of the bus bars is formed of a conductive member made of a metal such as copper, a copper alloy, aluminum, or an aluminum alloy.

The fuse is a member that protects the circuit board 35, the plurality of energy storage devices 21, and the like from a large current equal to or higher than a rated current. When a current equal to or higher than the rated current flows, the fuse is fused to cut off the flow of the current.

The circuit board 35 includes a plurality of electric components (not illustrated), and a detection circuit that detects a state (temperature, voltage, current, or the like) of each energy storage device 21, a control circuit that controls charge and discharge, and the like are formed by the plurality of electric components. The circuit board 35 may include at least one of a detection circuit and a control circuit.

The outer case body 11 and the outer case lid body 12 of the outer case 10 are formed of an insulating member such as polycarbonate (PC), polypropylene (PP), polyethylene (PE), polystyrene (PS), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), or an ABS resin, or a composite material thereof, an insulation-coated metal, or the like. With such a configuration, the outer case 10 prevents the energy storage devices 21 and the like from coming into contact with an external metal member or the like. The outer case 10 may be formed of a conductive member made of a metal or the like as long as the electric insulation property of the energy storage device 21 and the like is maintained. The outer case body 11 and the outer case lid body 12 may be formed of the same material or different materials.

### [Energy Storage Unit]

The energy storage unit 20 includes the plurality of energy storage devices 21 and a holding portion 22 that holds the plurality of energy storage devices 21.

The energy storage device 21 is a secondary battery (battery cell) capable of charging and discharging electricity, and more specifically, is a nonaqueous electrolyte secondary battery such as a lithium ion secondary battery. In the present embodiment, the energy storage device 21 is a pouch-type energy storage device having a flat shape, and a plurality of (in the present embodiment, four) pouch-type energy storage devices 21 are arranged side by side in the X-axis direction. The energy storage device 21 is not limited to a pouch-type energy storage device but may be an energy storage device having a flat rectangular parallelepiped shape (square shape), a cylindrical shape, an oval columnar shape, an elliptic columnar shape, or the like, and the size and the shape thereof are not limited. The number of the arranged energy storage devices 21 is also not particularly limited. The energy storage device 21 is not limited to a nonaqueous electrolyte secondary battery and may be a secondary battery other than the nonaqueous electrolyte secondary battery, or may be a capacitor. The energy storage device 21 may be not a secondary battery but a primary battery that allows the user to use stored electricity without charged electricity. The plurality of energy storage devices 21 are arranged in the X-axis direction, and the adjacent energy storage devices 21 may be joined to each other by an adhesive or a double-sided tape or may not be joined to each other. The details of the energy storage device 21 will be described later.

The holding portion 22 is a portion that holds the plurality of energy storage devices 21. The holding portion 22 includes a holding member 23 and a holding member 24 that holds the plurality of energy storage devices 21 together with the holding member 23. The holding member 23 is an example of a second holding member, and holding member 24 is an example of a first holding member. To be more specific, the holding member 23 is disposed in the X-axis negative direction of the plurality of energy storage devices 21 and is joined to the energy storage device 21 disposed at an end portion of the plurality of energy storage devices 21 in the X-axis negative direction by an adhesive agent or a double-sided tape. The holding member 24 is disposed in the X-axis positive direction of the plurality of energy storage devices 21 and is joined to the energy storage device 21 disposed at an end portion of the plurality of energy storage devices 21 in the X-axis positive direction by an adhesive agent or a double-sided tape. With such a configuration, the holding member 23 and the holding member 24 hold the plurality of energy storage devices 21 by sandwiching the plurality of energy storage devices in the X-axis direction. The holding member 23 is disposed opposite to the central portion of the energy storage device 21 disposed at the end portion in the X-axis negative direction, so that the plurality of energy storage devices 21 can be more stably held.

The same applies to the holding member 24. The central portion of the energy storage device 21 in the Z-axis direction is, for example, three intermediate regions obtained by dividing the energy storage device 21 into five equal parts in the Z-axis direction, two intermediate regions obtained by dividing the energy storage device into four equal parts, or one intermediate region obtained by dividing the energy storage device into three equal parts. The same applies to the Y-axis direction.

At least one of the holding members 23 and 24 may not be joined to the energy storage device 21. Even in this case, the holding members 23 and 24 can hold the plurality of energy storage devices 21 by the sandwiching force received from the outer case body 11 and the outer case lid body 12. Alternatively, the plurality of energy storage devices 21 may be held by fastening a screw bridged between the holding member 23 and the holding member 24.

The holding members 23 and 24 are formed of an insulating member such as polycarbonate (PC), polypropylene (PP), polyethylene (PE), a polyphenylene sulfide resin (PPS), polyphenylene ether (PPE (including modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), polyamide (PA), an ABS resin, or a composite material thereof. As a result, the holding members 23 and 24 suppress the conduction of the plurality of energy storage devices 21 with a conductive member such as an external metal member. If, however, there is no such need, the holding members 23 and 24 may be formed of a conductive member such as a metal.

The holding member 23 includes a flat plate portion 25 that overlaps the energy storage device 21 at an end portion in the X-axis negative direction and a bus bar support portion 26 that extends in the X-axis positive direction from the flat plate portion 25. The bus bar support portion 26 extends in the X-axis positive direction from the corner portion of the flat plate portion 25 which is located between the Y-axis negative direction and the Z-axis negative and supports a bus bar (not shown).

The holding member 24 includes a substrate support portion 27 that overlaps the energy storage device 21 at an end portion in the X-axis positive direction and a detection line support portion 28 that extends in the X-axis negative direction from the substrate support portion 27. The substrate support portion 27 supports the circuit board 35 and has a surrounding wall 29 surrounding the circuit board 35. The substrate support portion 27 supports a bus bar and a fuse (not illustrated).

The detection line support portion 28 is a portion that supports a plurality of detection lines 36 connected to the circuit board 35 in order to detect a state (temperature, voltage, current, or the like) of each energy storage device 21. The detection line support portion 28 extends in the X-axis negative direction from an end portion of the substrate support portion 27 in the Y-axis negative direction.

### [Energy Storage Device]

The details of the energy storage device 21 will be described below. As shown in FIG. 2, the plurality of energy storage devices 21 have the same basic structure but are partially different in outer shape. To be more specific, the outer shapes of the odd-numbered energy storage devices 21 in the order from the X-axis negative direction and the even-numbered energy storage devices 21 in the order from the X-axis negative direction are partially different from each other. That is, the odd-numbered energy storage devices 21 have the same outer shape, and the even-numbered energy storage devices 21 have the same outer shape.

The basic structure of the energy storage device 21 will be described. The energy storage device 21 includes an exterior film 210 and a pair of (positive electrode and negative electrode) lead terminals 220, and an electrode assembly (not shown), an electrolyte solution (nonaqueous electrolyte: not shown), and the like are accommodated in the exterior film 210. The type of electrolyte solution is not particularly limited as long as it does not impair the performance of the energy storage device 21, and a known material can be used as needed.

The exterior film 210 is a sheet-like outer case formed of a laminate film and hermetically accommodates therein an electrode assembly, an electrolyte solution, and the like in a decompressed state. The exterior film 210 is formed by stacking two rectangular laminate films in the X-axis direction. The two laminate films are joined (sealed) by thermal welding or the like with the pair of lead terminals 220 interposed therebetween. At portions of the two laminate films which do not correspond to the pair of lead terminals 220, the two laminate films are joined (sealed) to each other by thermal welding or the like. The laminate film is a flexible film formed of a plurality of layers including a metal layer made of aluminum or the like and a resin layer made of polypropylene (PP), polyethylene (PE), or the like, and a resin layer is disposed at a welded portion (seal portion). The exterior film 210 may be configured by forming one sheet of laminate film into a bag shape and joining end portions of the laminate film to each other by thermal welding.

The lead terminal 220 is a conductive plate-like member (lead plate) electrically connected to the electrode assembly and is disposed to be exposed from the exterior film 210 in a state of penetrating the exterior film 210. In the present embodiment, the pair of lead terminals 220 arranged side by side in the Z-axis direction are disposed so as to protrude in the Y-axis negative direction from the end portion of the exterior film 210 in the Y-axis negative direction. Specifically, the lead terminal 220 of the positive electrode is a lead terminal electrically connected to the positive electrode plate of the electrode assembly, and the lead terminal 220 of the negative electrode is a lead terminal electrically connected to the negative electrode plate of the electrode assembly. The lead terminal 220 is a metal electrode terminal for leading out electricity stored in the electrode assembly to a space outside the energy storage device 21 and for introducing electricity into a space inside the energy storage device 21 for storing electricity in the electrode assembly. The lead terminal 220 is made of aluminum, an aluminum alloy, copper, a copper alloy, or the like.

The electrode assembly is an energy storage element (power generating element) formed by stacking a positive electrode plate, a negative electrode plate, and a separator. The positive electrode plate is formed by forming a positive active material layer on a current collecting foil made of metal such as aluminum or an aluminum alloy. The negative electrode plate is obtained by forming a negative active material layer on a current collecting foil made of metal such as copper or a copper alloy. As an active material used for the positive active material layer and the negative active material layer, a known material can be appropriately used as long as it can occlude and release lithium ions. As the separator, a microporous sheet or nonwoven fabric made of a resin can be used. In the present embodiment, the electrode assembly is formed by stacking plates (a positive electrode plate and a negative electrode plate) in the X axis direction. The electrode assembly may be an electrode assembly in any form such as a wound electrode assembly formed by winding plates (a positive electrode plate and a negative electrode plate), a stacking-type (stack-type) electrode assembly formed by stacking a plurality of plate-shaped plates, or a bellows-type electrode assembly formed by folding the plates in a bellows shape.

### [Joining Structure Between Outer Case and Energy Storage Unit]

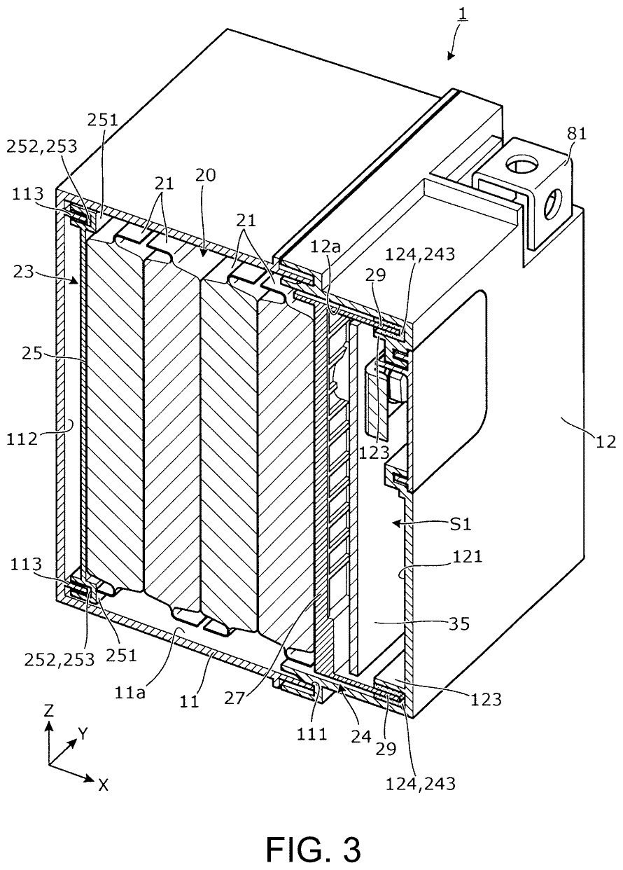

A joining structure between the outer case 10 and the energy storage unit 20 will be described. FIG. 3 is a cross-sectional perspective view showing a joining structure between an outer case and an energy storage unit according to the embodiment. Specifically, FIG. 3 is a cross-sectional perspective view taken along line III-III in FIG. 1.

As shown in FIG. 3, the holding member 23 of the energy storage unit 20 is joined to the outer case body 11 of the outer case 10. To be more specific, in the outer case body 11, a bottom frame 113 that projects in the X-axis positive direction is formed on an inner bottom surface 112 that faces the opening 111 in the X-axis direction. The bottom frame 113 is provided continuously or intermittently along the entire peripheral edge of the inner bottom surface 112. The bottom frame 113 is disposed at a predetermined interval from the inner surface 11a of the outer case body 11.

The peripheral edge of the flat plate portion 25 of the holding member 23 is provided with an edge portion 251 continuously or intermittently along the entire periphery. The edge portion 251 protrudes from both sides of the flat plate portion 25 in the X axis direction. On an end surface of the edge portion 251 in the X-axis negative direction, a first groove 252 is formed continuously or intermittently along the entire periphery. The bottom frame 113 is inserted into first groove 252 through an adhesive 253. The first groove 252 and the bottom frame 113 are joined to each other by being wholly or partially bonded with the adhesive 253.

The holding member 24 of the energy storage unit 20 is joined to the outer case lid body 12 of the outer case 10. To be more specific, in the outer case lid body 12, a lid frame 123 that projects in the X-axis negative direction is formed on an inner top surface 121 that faces the opening 111 in the X-axis positive direction.

The lid frame 123 is annularly continuous in the inner top surface 121. The lid frame 123 is disposed at a predetermined interval from an inner surface 12a of the outer case lid body 12. A second groove 124 is formed by the lid frame 123 and an inner surface 12a of the outer case lid body 12. A distal end portion (an end portion in the X-axis positive direction) of the surrounding wall 29 of the holding member 24 is inserted into the second groove 124 through an adhesive 243. The surrounding wall 29 of the holding member 24 is joined to the second groove 124 of the outer case lid body 12 with an adhesive 243 over the entire periphery.

As described above, since the holding member 23 is joined to the outer case body 11 and the holding member 24 is joined to the outer case lid body 12, the energy storage unit 20 is fixed to both sides inside the outer case 10. In this state, a gap S1 is formed between the substrate support portion 27 and the outer case lid body 12. The gap S1 is disposed at a position corresponding to the plurality of energy storage devices 21 as viewed in the X-axis direction. That is, the gap S1 is formed between the portion of the substrate support portion 27 which faces the energy storage devices 21 and the outer case lid body 12. Even if the plurality of energy storage devices 21 expand, since the gap S1 absorbs the expansion, the expansion is hardly transmitted to the outer case lid body 12. The circuit board 35 is disposed inside the surrounding wall 29 in the gap S1. As described above, since the distal end portion of the surrounding wall 29 is bonded to the second groove 124 of the outer case lid body 12 over the entire periphery with the adhesive 243, the internal space of the surrounding wall 29 is sealed.

When the energy storage unit 20 is assembled to the outer case 10 at the time of manufacture, first, an operator applies the adhesive 253 to the bottom frame 113 of the outer case body 11 or the first groove 252 of the holding member 23. Thereafter, the operator arranges the energy storage unit 20 in the X-axis positive direction of the outer case body 11 and moves the energy storage unit 20 in the X-axis negative direction to accommodate the energy storage unit in the outer case body 11 through the opening 111. At the time of this accommodation, the bottom frame 113 is inserted into the first groove 252. Accordingly, the first groove 252 and the bottom frame 113 are bonded to each other with the adhesive 253.

Next, the operator applies the adhesive 243 to the second groove 124 of the outer case lid body 12 or the surrounding wall 29 of the holding member 24.

Thereafter, the operator disposes the outer case lid body 12 in the X-axis positive direction of the outer case body 11 and moves the outer case lid body 12 in the X-axis negative direction to assemble and bond the outer case lid body 12 to the outer case body 11. At this time, the surrounding wall 29 of the holding member 24 is inserted into the second groove 124. As a result, the second groove 124 and the surrounding wall 29 are bonded with the adhesive 243. That is, the bonding between the outer case body 11 and the outer case lid body 12 and the bonding between the second groove 124 and the surrounding wall 29 are performed in the same step. In particular, since the exterior film 210 of the energy storage device 21 is formed of a flexible laminate film, the energy storage device 21 and the holding members 23 and 24 can be more closely attached to each other. That is, the holding members 23 and 24 can firmly hold the energy storage device 21. Further, when the plurality of energy storage devices 21 are arranged side by side in the X-axis direction, the adjacent energy storage devices 21 can be brought into close contact with each other. That is, the holding members 23 and 24 can firmly hold the plurality of energy storage devices 21.

The energy storage unit 20 may be assembled to the outer case 10 in a reverse process to the above-mentioned process. That is, after the surrounding wall 29 of the holding member 24 is bonded to the second groove portion 124 of the outer case lid body 12, the energy storage unit 20 may be inserted into the outer case body 11 so that the bottom frame 113 of the outer case body 11 and the first groove 232 of the holding member 23 are bonded to each other.

### [Effects and the Like]

As described above, according to the present embodiment, since the holding member 24 provided at the end portion of the energy storage unit 20 is joined to the outer case 10, the energy storage unit 20 is fixed on at least one side in the outer case 10. Accordingly, the energy storage unit 20 is stabilized inside the outer case 10. Accordingly, it is possible to enhance the vibration resistance or impact resistance of the energy storage apparatus 1.

Since the energy storage unit 20 is accommodated in the outer case body 11 having an opening in one end portion in a predetermined direction (X-axis direction), the holding member 23 provided at the other end portion of the energy storage unit 20 can be joined to the outer case body 11 only by accommodating the energy storage unit 20 in the outer case body 11. Further, when the outer case lid body 12 is attached to one end portion of the outer case body 11, the holding member 24 provided at one end portion of the energy storage unit 20 can be joined to the outer case lid body 12. In this manner, the holding members 23 and 24 provided at the end portion of the energy storage unit 20 can be smoothly joined to the outer case 10.

Since the plurality of energy storage devices 21 are sandwiched and held by the holding members 23 and 24, the plurality of energy storage devices 21 are further stabilized inside the outer case 10 by the holding members 23 and 24. Further, since the holding member 24 is joined to the outer case lid body 12 and the holding member 23 is joined to the outer case body 11, the energy storage unit 20 is fixed on both sides in the outer case 10. Accordingly, it is possible to further enhance the vibration resistance or impact resistance of the energy storage apparatus 1.

Since the gap S1 is formed between the holding member 24 and the outer case lid body 12 at the position corresponding to the plurality of energy storage devices 21, the expansion of the plurality of energy storage devices 21 can be absorbed by the gap S1. Therefore, it is possible to suppress the deformation of the outer case 10 caused by the expansion of the plurality of energy storage devices 21.

Since the circuit board 35 is disposed in the gap S1, the circuit board 35 can be accommodated without providing a dedicated member for covering the circuit board 35. If a dedicated member is unnecessary, the weight can be reduced, whereby the vibration resistance or the impact resistance can be further enhanced. Further, when a dedicated member is unnecessary, space saving in the outer case 10 is also possible, and the energy storage apparatus 1 can be downsized.

### (First Modification)

Hereinafter, the first modification of the above embodiment will be described. In the following description, the same parts as those in the above embodiment or other modification examples are denoted by the same reference numerals, and a description thereof may be omitted.

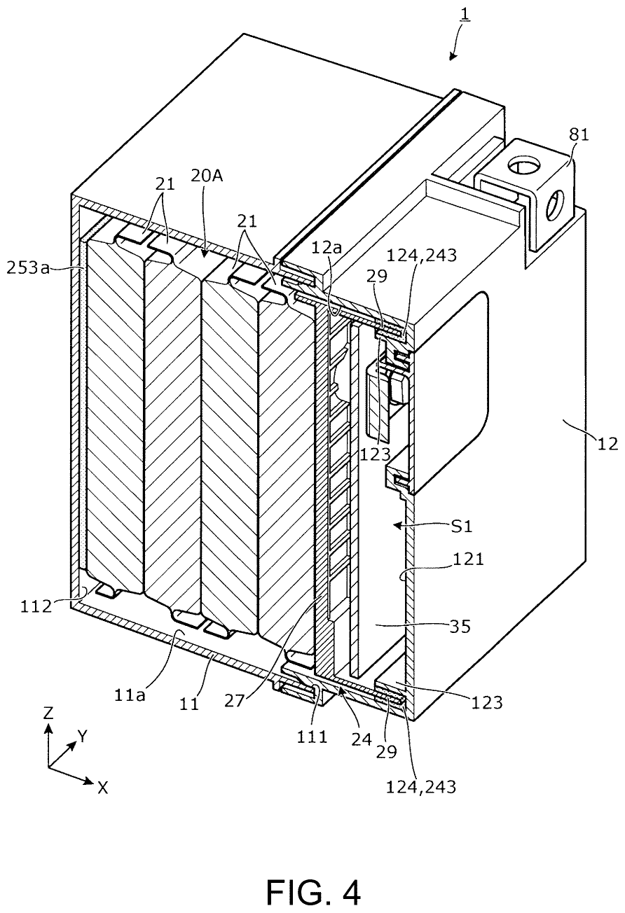

In the above-mentioned embodiment, the energy storage unit 20 that includes the pair of holding members 23 and the pair of holding members 24 is exemplified. In the first modification, an energy storage unit including only one holding member will be described. FIG. 4 is a cross-sectional perspective view showing a joining structure between an outer case and an energy storage unit according to the first modification. Specifically, FIG. 4 is a diagram corresponding to FIG. 3.

As shown in FIG. 4, an energy storage unit 20A includes the holding member 24 that is the first holding member but does not include the holding member 23 that is the second holding member. Accordingly, an end portion of the energy storage unit 20A in the X-axis negative direction becomes the first energy storage device 21 in the X-axis negative direction. An adhesive 253a is interposed between the first energy storage device 21 and the inner bottom surface 112 of the outer case body 11, and the energy storage device 21 and the inner bottom surface 112 are bonded and joined to each other. That is, also in this case, the energy storage unit 20A is fixed on both sides in the outer case 10.

### (Others)

Although the energy storage apparatus according to the embodiment of the present invention has been described above, the present invention is not limited to the present embodiment. That is, the embodiment disclosed herein is exemplary in all respects and not exhaustive, and the scope of the present invention includes all modifications within the meaning and scope equivalent to the claims.

In the above embodiment, the holding member 24 is an example of the first holding member, and the holding member 23 is an example of the second holding member. However, the relationship between the first holding member and the second holding member may be reversed. Specifically, the holding member 23 may be an example of the first holding member, and the holding member 24 may be an example of the second holding member. For example, when the holding member 23 is an example of the first holding member, the holding member 24 is removed as in the first modification, and the fourth energy storage device 21 can be joined (bonded) to the outer case lid body 12.

Further, as long as the first holding member is joined to the outer case, the second holding member may not be joined to the outer case. Even in this case, since the energy storage unit is fixed inside the outer case, the energy storage unit is stabilized in the outer case. Accordingly, it is possible to enhance the vibration resistance or impact resistance of the energy storage apparatus.

In the above embodiment, bonding has been exemplified as a method of joining objects to each other. However, the objects to be joined may be joined by a method other than bonding. Other methods include welding and fixing with bolts and nuts.

The above-mentioned embodiment has exemplified the case where the gap

S1 is formed between the substrate support portion 27 of the holding member 24 and the outer case lid body 12. However, a gap may be formed between the holding member 23 and the inner bottom surface 112 of the outer case body 11. Even with this gap, the expansion of the energy storage device 21 can be absorbed, and the deformation of the outer case caused by the expansion can be suppressed. The gap may be formed at least between the holding member 24 and the outer case lid body 12 or between the holding member 23 and the outer case body 11. The gap may not be provided.

The above-mentioned embodiment has exemplified the case where the circuit board 35 is disposed in the gap S1 between the substrate support portion 27 of the holding member 24 and the outer case lid body 12. When a gap is formed between the holding member 23 and the inner bottom surface 112 of the outer case body 11, the circuit board 35 may be disposed in the gap. The circuit board may not be disposed in the gap.

The above-mentioned embodiment has exemplified the outer case body 11 having the opening 111 in the end portion in the X-axis direction (predetermined direction). For example, the outer case body may have an opening in the end portion in a direction intersecting the X-axis direction.

A mode constructed by arbitrarily combining the constituent elements included in the embodiment and the modification thereof is also included in the scope of the present invention.

### INDUSTRIAL APPLICABILITY

The present invention can be applied to an energy storage apparatus or the like including an energy storage device such as a lithium ion secondary battery.

### DESCRIPTION OF REFERENCE SIGNS

1: energy storage apparatus
10: outer case
11: outer case body
11a, 12a: inner surface
12: outer case lid body
20, 20A: energy storage unit
21: energy storage device
22: holding portion
23: holding member (second holding member)
24: holding member (first holding member)
25: flat plate portion
26: bus bar support portion
27: substrate support portion
28: detection line support portion
29: surrounding wall
35: circuit board
36: detection line
81: external terminal
111: opening
112: inner bottom surface
113: bottom frame
121: inner top surface
123: lid frame
124: second groove
210: exterior film
220: lead terminal
243, 253, 253a: adhesive
251: edge portion
252: first groove
S1: gap

1. An energy storage apparatus comprising:
an energy storage unit; and
an outer case that accommodates the energy storage unit, wherein the energy storage unit includes:
a plurality of energy storage devices arrayed in a predetermined direction, and
a first holding member that is adjacent to the plurality of energy storage devices in the predetermined direction and holds the plurality of energy storage devices, and
the first holding member is joined to the outer case.

2. The energy storage apparatus according to claim 1, wherein
the outer case includes:
an outer case body having an opening in one end portion in the predetermined direction, and
an outer case lid body that is attached to the one end portion of the outer case body and closes the opening.

3. The energy storage apparatus according to claim 1, wherein
the energy storage unit further includes a second holding member that holds the plurality of energy storage devices, and
the second holding member is disposed at a position where the second holding member interposes the plurality of energy storage devices together with the first holding member in the predetermined direction, and is joined to the outer case.

4. The energy storage apparatus according to claim 3, wherein a gap is formed between at least one of the first holding member and the second holding member and the outer case at a position corresponding to the plurality of energy storage devices.

5. The energy storage apparatus according to claim 4, wherein a circuit board is disposed in the gap.
